(19) United States
(12) Patent Application Publication
(10) Pub. No.: US 2022/0077787 A1
(43) Pub. Date: Mar. 10, 2022

(54) POWER SUPPLY APPARATUS

(71) Applicant: SONY GROUP CORPORATION, TOKYO (JP)

(72) Inventor: MASAYOSHI KOKI, TOKYO (JP)

(21) Appl. No.: 17/309,662

(22) PCT Filed: Dec. 12, 2019
(86) PCT No.: PCT/JP2019/048638

§ 371 Date: Jun. 14, 2021

(30) Foreign Application Priority Data
Dec. 21, 2018 (JP) 2018-240208

(51) Int. Cl. H02M 3/335; H02M 1/08; H02M 1/00

(52) U.S. Cl. CPC H02M 3/33569; H02M 1/0058; H02M 1/083

(57) ABSTRACT

There are provided a first arm circuit and a second arm circuit (1020, 1021) each including an upper arm and a lower arm; a series resonant circuit including a first inductor (Lr1) and a capacitor (Cr1), the first inductor having one end thereof connected with a first end of primary winding of a transformer (Tr), the capacitor being connected with the other end of the first inductor; a second inductor (Lr2) having one end thereof connected with a connection point connecting the upper arm with the lower arm in the second arm circuit; and a control circuit (10) controlling drive of the first and the second arm circuits. A connection point connecting the upper arm with the lower arm in the first arm circuit is connected with a second end of the primary winding of the transformer. A connection point connecting the first inductor with the capacitor is connected with the other end of the second inductor.

### TECHNICAL FIELD

The present invention relates to a power supply apparatus.

### BACKGROUND ART

There exists a known switching power supply apparatus based on an LLC current resonant power supply that uses two inductors (L) and one capacitor (C) (the apparatus will be referred to as the LLC switching power supply apparatus hereunder).

Typically, the existing LLC switching power supply apparatus includes an upper arm and a lower arm connected in series with each other and configured with a switching element each, a series resonant circuit having a capacitor and an inductor, and a transformer connected with the series resonant circuit. The LLC switching power supply apparatus drives the upper and lower arms alternately to generate an alternating current and allows the series resonant circuit to act on the alternating current, thereby causing the secondary winding of the transformer to provide an output corresponding to a direct-current power supply being input.

### CITATION LIST

### Patent Literature

### PTL 1

JP 2015-177595A

### SUMMARY

### Technical Problem

In recent years, the LLC switching power supply apparatus has been employed extensively because of its relatively simple configuration for providing a power supply efficiently. Thus, there has been a need for further developing the characteristics of the apparatus and thereby improving its usefulness.

The present disclosure is aimed at providing a more useful power supply apparatus.

### Solution to Problem

In order to achieve the above object and according to the present disclosure, there is provided a power supply apparatus including a first arm circuit, a second arm circuit, a transformer, a series resonant circuit, a second inductor, and a control circuit. The first arm circuit includes a first switching element and a second switching element, the first and second switching elements being connected in series between positive and negative terminals of a direct-current power supply, the first switching element constituting an upper arm, the second switching element constituting a lower arm. The second arm circuit includes a third switching element and a fourth switching element, the third and fourth switching elements being connected in series between the positive and negative terminals of the direct-current power supply, the third switching element constituting an upper arm, the fourth switching element constituting a lower arm. The transformer includes primary winding, and secondary winding with which an output circuit outputting a direct current is connected. The series resonant circuit includes a first inductor and a capacitor, the first inductor having one end thereof connected with a first end of the primary winding, the capacitor being connected with the other end of the first inductor. The second inductor has one end thereof connected with a connection point connecting the third switching element with the fourth switching element in series. The control circuit controls drive of the first arm circuit and the second arm circuit. A connection point connecting the first switching element with the second switching element in series is connected with a second end of the primary winding of the transformer. A connection point connecting the first inductor with the capacitor is connected with the other end of the second inductor.

### BRIEF DESCRIPTION OF DRAWINGS

FIG. 1 is a circuit diagram depicting an example of a configuration of a power supply apparatus according to the existing technology.

FIG. 2 is a circuit diagram of an example that takes into consideration parasitic elements of the power supply apparatus of the existing technology.

FIG. 3A is a diagram explaining more specifically an operation of the power supply apparatus of the existing technology.

FIG. 3B is another diagram explaining more specifically the operation of the power supply apparatus of the existing technology.

FIG. 3C is still another diagram explaining more specifically the operation of the power supply apparatus of the existing technology.

FIG. 3D is yet another diagram explaining more specifically the operation of the power supply apparatus of the existing technology.

FIG. 4 is a circuit diagram depicting an example of a configuration of a power supply apparatus practiced as a first embodiment.

FIG. 5 is a circuit diagram of an example that takes into consideration parasitic elements of the power supply apparatus as the first embodiment.

FIG. 6 is a block diagram depicting an example of a more detailed configuration of a control unit usable with the first embodiment.

FIG. 7 is a diagram depicting typical drive signals used by the control unit of the first embodiment to drive switching elements.

FIG. 8 is a diagram depicting an example of comparing output of the power supply apparatus as the first embodiment with output of the power supply apparatus of the existing technology.

FIG. 9 is a diagram explaining more specifically control performed by a first alternative example of the first embodiment.

FIG. 10 is a diagram depicting an example of how components incur variations when an operation of a second arm circuit is switched from a stopped state to an operating state.

FIG. 11 is a diagram depicting an example of how output voltage measurements vary when duty of the drive signals supplied to the second arm circuit is gradually varied by a second alternative example of the first embodiment.

FIG. 12 is a diagram depicting how components incur variations when the operation of the second arm circuit is switched from the operating state to the stopped state in the second alternative example of the first embodiment.

FIG. 13A is a diagram for examining how variations in the output voltage are suppressed at a switching point in the second alternative example of the first embodiment.

FIG. 13B is another diagram for examining how variations in the output voltage are suppressed at the switching point in the second alternative example of the first embodiment.

FIG. 13C is still another diagram for examining how variations in the output voltage are suppressed at the switching point in the second alternative example of the first embodiment.

FIG. 13D is yet another diagram for examining how variations in the output voltage are suppressed at the switching point in the second alternative example of the first embodiment.

FIG. 14 is a circuit diagram depicting an example of a configuration of a power supply apparatus as a fourth alternative example of the first embodiment.

FIG. 15 is a diagram depicting typical drive signals used by a control unit 10 of a second embodiment to drive switching elements.

FIG. 16 is a diagram depicting an example of a result of simulating characteristics using an equivalent circuit of an LLC switching power supply apparatus of the existing technology.

FIG. 17 is a diagram depicting an example of a result of simulating characteristics in the case where drive signals of opposite phase are added to an equivalent circuit of an LLC switching power supply apparatus as the second embodiment.

### DESCRIPTION OF EMBODIMENTS

Some preferred embodiments of the present disclosure are described below in detail with reference to the accompanying drawings. Incidentally, in the ensuing description of the embodiments, like components are designated by like reference signs, and the repetitive explanations are omitted.

### First Embodiment

Explained below is a switching power supply apparatus based on an LLC current resonant power supply and practiced as a first embodiment of the present disclosure (simply referred to as the power supply apparatus hereunder). To help understanding of this apparatus, a power supply apparatus according to the existing technology is explained first.

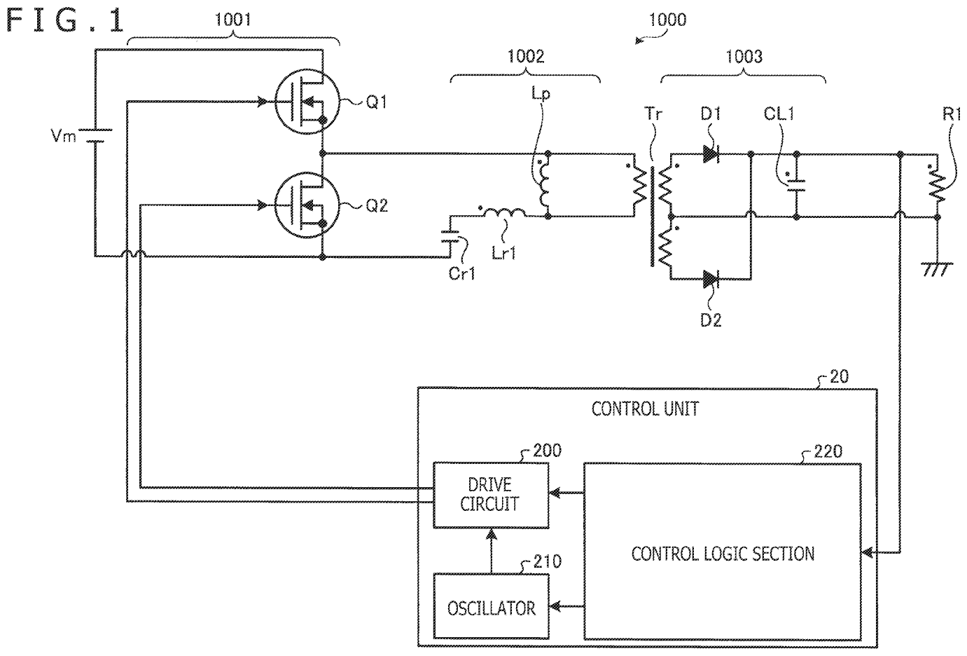

FIG. 1 is a circuit diagram depicting an example of a configuration of a power supply apparatus according to the existing technology. In FIG. 1, a power supply apparatus 1000 of the existing technology includes an arm circuit section 1001, a resonant circuit section 1002, a transformer Tr, an output circuit section 1003, and a control unit 20. The transformer Tr includes primary and secondary windings. In the description that follows, that side of the primary winding which is devoid of a solid black circle in the drawing will be referred to as the first end, and the side provided with the solid black circle will be referred to as the second end.

The arm circuit section 1001 includes a switching element Q1 and a switching element Q2 connected in series with each other and constituting an upper arm and a lower arm, respectively. For example, the switching elements Q1 and Q2 each use an N-type MOSFET (Metal Oxide Semiconductor Field Effect Transistor) and are controlled to be on (closed state) and off (opened state) by drive signals supplied from the control unit 20, which will be discussed later, to the gate of the transistors. The source of the switching element Q1 is connected with the drain of the switching element Q2, which connects the switching elements Q1 and Q2 in series with each other. The drain of the switching element Q1 is connected with the positive terminal of a direct-current power supply Vm serving as an input. The source of the switching element Q2 is connected with the negative terminal of the direct-current power supply Vm. Also, a connection point connecting the switching element Q1 with the switching element Q2 in series is connected with the second end of the primary winding of the transformer Tr.

The resonant circuit section 1002 includes a series resonant circuit constituted by an inductor Lr1 and a capacitor Cr1 connected in series with each other. That end of the series resonant circuit which is on the side of the inductor Lr1 is connected with the first end of the primary winding of the transformer Tr. The end of the series resonant circuit on the side of the capacitor Cr1 is connected with the source of the switching element Q2 and with the negative terminal of the direct-current power supply Vm.

An inductor Lp operates on the excitation inductance of the primary winding of the transformer Tr. In the example of FIG. 1, the inductor Lp is depicted as connected in parallel with the primary winding of the transformer Tr.

The secondary winding of the transformer Tr is connected with the output circuit section 1003. In the example of FIG. 1, the output circuit section 1003 includes diodes D1 and D2 and a smoothing capacitor CL1. The output circuit section 1003 causes the diodes D1 and D2 to perform two-phase full-wave rectification on an alternating current taken from the secondary winding of the transformer Tr, allows the smoothing capacitor CL1 to smooth the rectified output, and sends the smoothed output to the load represented by a resistor R1 as a direct-current power supply.

The control unit 20 includes a drive circuit 200, an oscillator 210, and a control logic section 220. The oscillator 210 generates signals based on a frequency designated by the control logic section 220 and on PWM (Pulse Width Modulation) of the duty. The drive circuit 200 drives the switching elements Q1 and Q2 according to the PWM-based signals generated by the oscillator 210. At this time, the drive circuit 200 drives the switching element Q1 on the basis of the signals generated by the oscillator 210 and also drives the switching element Q2 based on inversion signals obtained by inversing the oscillator-generated signals.

The output of the output circuit section 1003 is also supplied to the control logic section 220. For example, on the basis of the supplied output voltage value of the output circuit section 1003, the control logic section 220 controls the frequency and duty (referred to as the duty hereunder) of the PWM-based drive signals generated by the oscillator 210. This feedback control stabilizes the output of the output circuit section 1003.

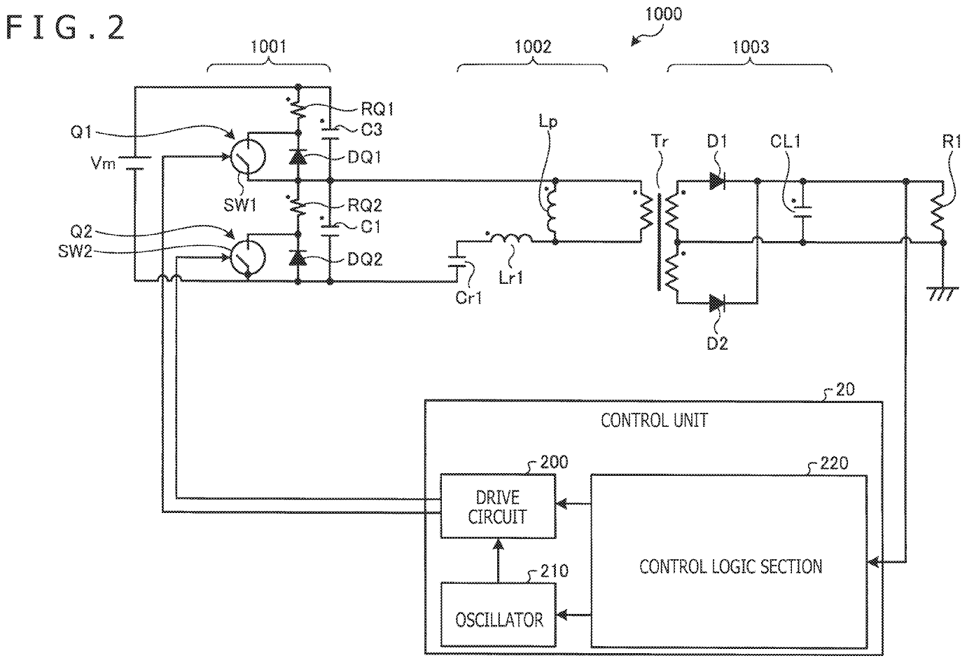

FIG. 2 is a circuit diagram of an example that takes into consideration the parasitic elements of the above-described power supply apparatus 1000 of the existing technology depicted in FIG. 1. In FIG. 2, the switching element Q1 includes a switch SW1, a diode DQ1, a resistor RQ1, and a capacitor C3. The switch SW1 is controlled to be on and off by drive signals supplied from the drive circuit 200. The anode of the diode DQ1 is connected with one end of the switch SW1 and with one end of the capacitor C3. A connection point connecting the anode of the diode DQ1, one end of the switch SW1, and one end of the capacitor C3 corresponds to the source of the switching element Q1. The cathode of the diode DQ1 is connected with one end of the resistor RQ1. The other end of the resistor RQ1 is connected with the other end of the capacitor C3. A connection point connecting the other end of the resistor RQ1 with the other end of the capacitor C3 corresponds to the drain of the switching element Q1. A connection point connecting the cathode of the diode DQ1 with the resistor RQ1 is connected with the other end of the switch SW1.

The switching element Q2 is configured similarly to the switching element Q1. That is, the switching element Q2 includes a switch SW2, a diode DQ2, a resistor RQ2, and a capacitor C1 corresponding, respectively, to the switch SW1, the diode DQ1, the resistor RQ1, and the capacitor C3 of the switching element Q1. The connection relation between the switch SW2, the diode DQ2, the resistor RQ2, and the capacitor C1 is similar to the above-described connection relation between the switch SW1, the diode DQ1, the resistor RQ1, and the capacitor C3 and thus will not be discussed further in detail.

The inductor Lr1 is connected interposingly between the second end of the primary winding of the transformer Tr and one end of the capacitor Cr1. For example, the inductor Lr1 is a leakage inductance of the primary winding of the transformer Tr. The second end of the primary winding of the transformer Tr is connected with the connection point connecting the capacitor C1 with the capacitor C3.

In keeping with the PWM-based drive signals generated by the drive circuit 200, the control unit 20 drives alternately the switches SW1 and SW2 to let the direct-current power supply Vm generate an alternating current on the primary winding side of the transformer Tr. This allows the secondary winding side of the transformer Tr to generate an alternating current commensurate with the winding ratio of the transformer Tr. The alternating current generated on the secondary winding side of the transformer Tr is rectified by the diodes D1 and D2 of the output circuit section 1003, before being smoothed by the smoothing capacitor CL1 and output as a direct-current power supply to the load represented by the resistor R1.

At this time, in alternating between the switches SW1 and SW2, the control unit 20 performs zero-voltage switching (ZVS) that involves turning on the switch SW2 in a state in which the voltage of the switch SW2 (switching element Q2) is approximately 0 V, for example.

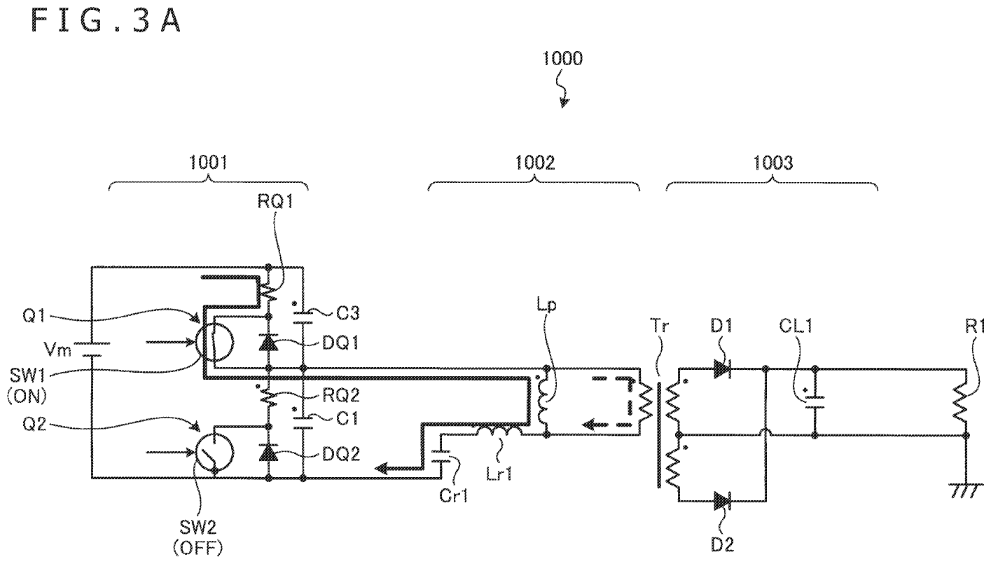

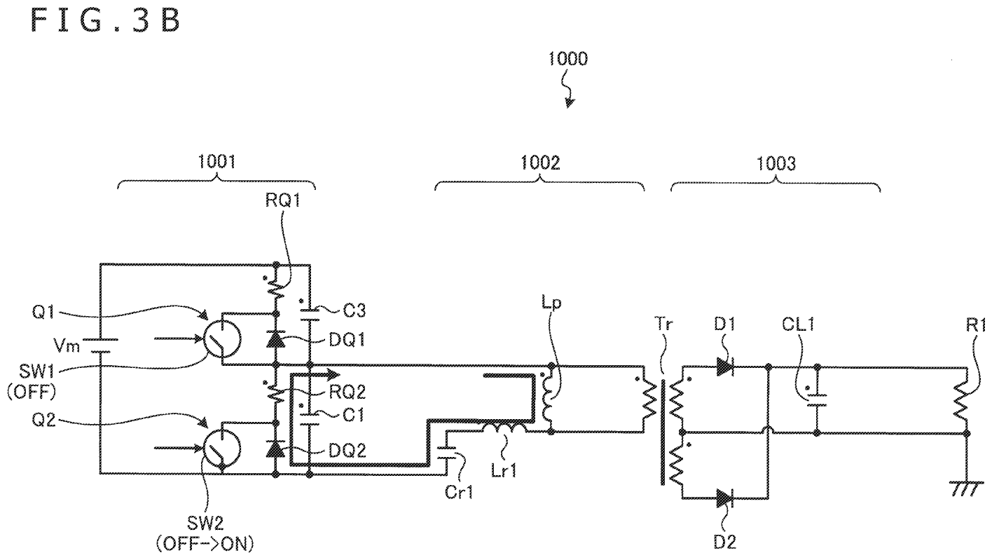

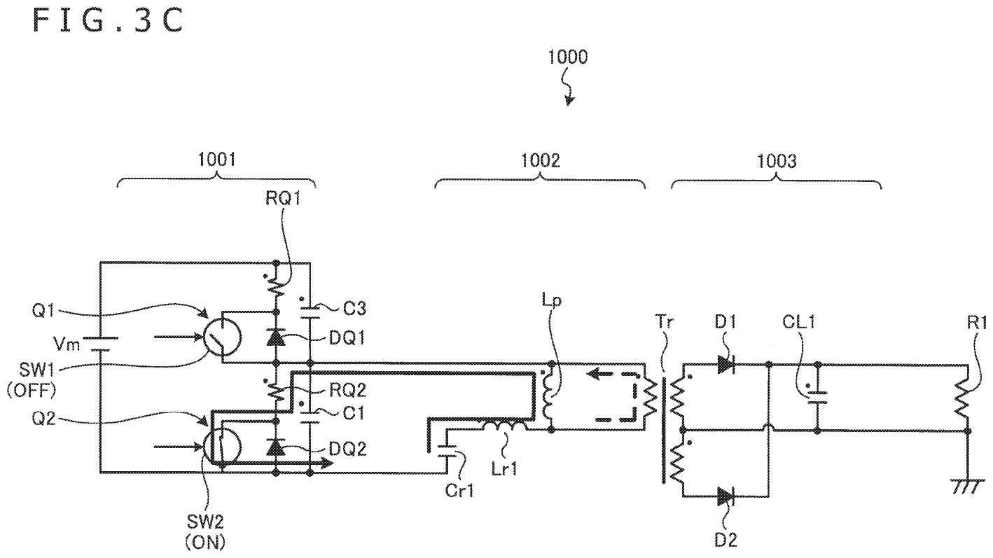

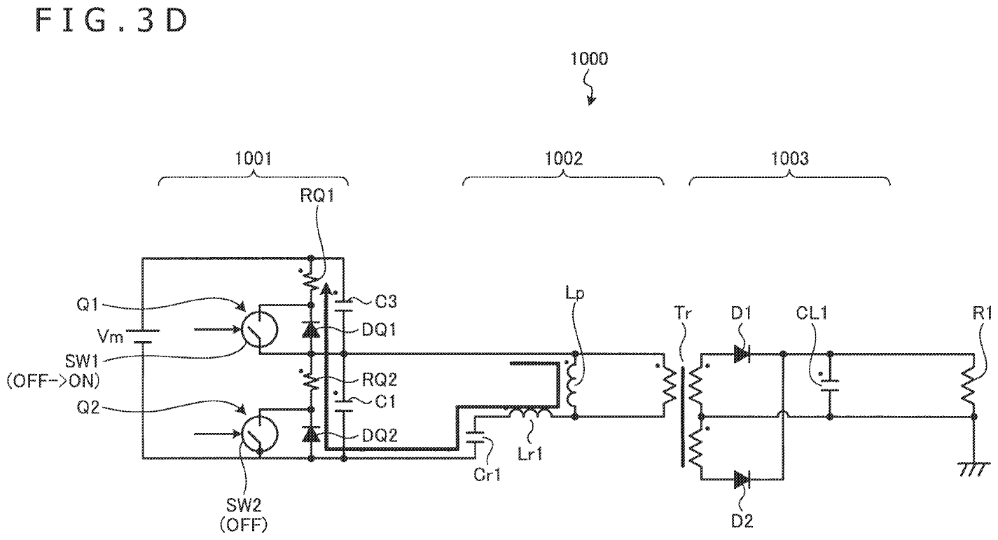

FIGS. 3A to 3D are diagrams explaining more specifically the operations of the power supply apparatus 1000 of the existing technology. First, consider a state in which the switch SW1 (switching element Q1) is in an on-state and the switch SW2 (switching element Q2) is in an off-state as depicted in FIG. 3A. In this case, with the switch SW1 in the on-state, a positive-direction current flows through the switch SW1. As indicated by a solid-line arrow in FIG. 3A, this current is supplied from the switch SW1 (switching element Q1) via the inductor Lp to the series resonant circuit constituted by the inductor Lr1 and capacitor Cr1.

Incidentally, a dotted-line arrow in FIGS. 3A and 3C indicates a current flowing into the primary winding of the transformer Tr.

Next, with the positive-direction current flowing through the switch SW1, the switch SW1 is turned off. Immediately after the switch SW1 is turned off, a negative-direction current flows on the side of the switching element Q2 via the diode DQ2 included in the switching element Q2, as indicated by a solid-line arrow in FIG. 3B. A resonant current in the series resonant circuit varies continuously. While the current is flowing through the diode DQ2, the switch SW2 is turned on. At this time, zero-voltage switching (ZVS) is performed by which the switch SW2 is turned on in the state where the voltage of the switching element Q2 is approximately 0 V.

With the switch SW2 turned on, a positive-direction current flows through the switch SW2 (switching element Q2) as depicted in FIG. 3C. If the switch SW2 is turned off in this state, a negative-direction current flows immediately after the switch-off on the side of the switching element Q1 via the diode DQ1 included in the switching element Q1, as indicated by a solid-line arrow in FIG. 3D. The resonant current in the series resonant circuit varies continuously. While the current is flowing through the diode DQ1, the switch SW1 is turned on by ZVS. This brings back the state of FIG. 3A. Thereafter, the switches SW1 and SW2 (the switching elements Q1 and Q2) are drive-controlled successively as described above, in such a manner that the operations in FIGS. 3A to 3D are carried out cyclically.

### Configuration of the First Embodiment

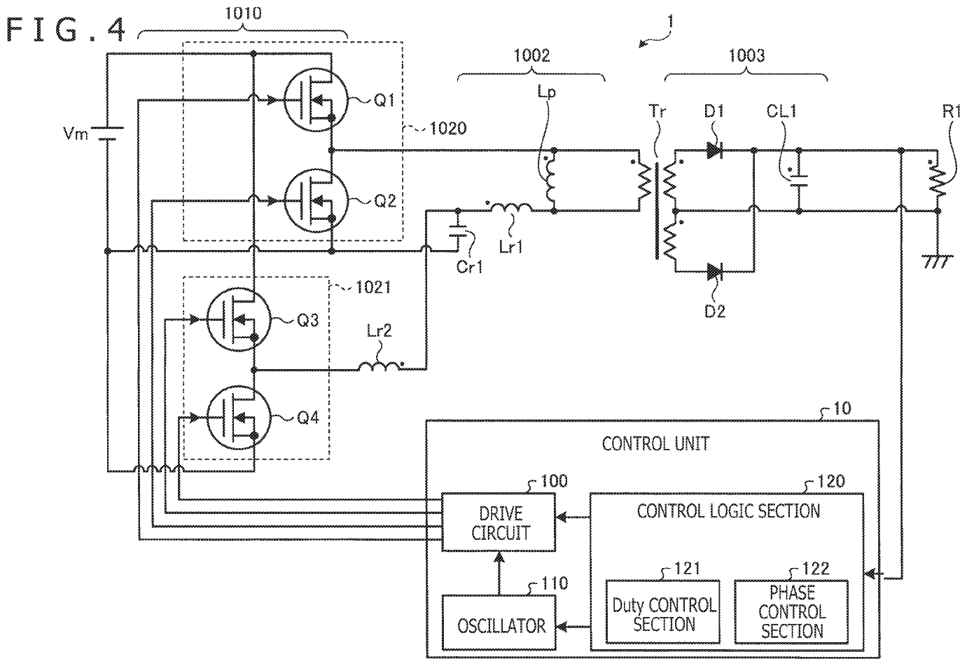

The configuration of the first embodiment is explained next. FIG. 4 is a circuit diagram depicting an example of a configuration of a power supply apparatus practiced as the first embodiment. In FIG. 4, a power supply apparatus 1 as the first embodiment is configured with switching elements Q3 and Q4 and an inductor Lr2 added to the configuration of the power supply apparatus 1000 of the existing technology depicted in FIG. 1.

In the power supply apparatus 1, an arm circuit section 1010 includes a first arm circuit section 1020 and a second arm circuit section 1021, the first arm circuit section 1020 corresponding to the above-mentioned arm circuit section 1001, the second arm circuit section 1021 including the switching elements Q3 and Q4 that are connected in series with each other and that constitute an upper arm and a lower arm, respectively.

In the second arm circuit section 1021, the source of the switching element Q3 is connected with the drain of the switching element Q3, which connects the switching elements Q3 and Q4 in series with each other. The drain of the switching element Q3 is connected with the positive terminal of a direct-current power supply Vm serving as an input. The source of the switching element Q4 is connected with the negative terminal of the direct-current power supply Vm. That is, the first arm circuit section 1020 and the second arm circuit section 1021 are connected in parallel with the direct-current power supply Vm.

A connection point connecting the switching element Q3 with the switching element Q4 in series is connected with one end of the inductor Lr2. The other end of the inductor Lr2 is connected with a connection point connecting the inductor Lr1 with the capacitor Cr1. That is, the connection point connecting the switching element Q3 with the switching element Q4 is connected with the first end of the primary winding of the transformer Tr via the inductors Lr2 and Lr1.

Further, a control unit 10 corresponding to the above-mentioned control unit 20 includes a drive circuit 100, an oscillator 110, and a control logic section 120 corresponding, respectively, to the drive circuit 200, the oscillator 110, and the control logic section 120. The drive circuit 100 is capable of controlling the switching elements Q1, Q2, Q3, and Q4 independently of one another, for example.

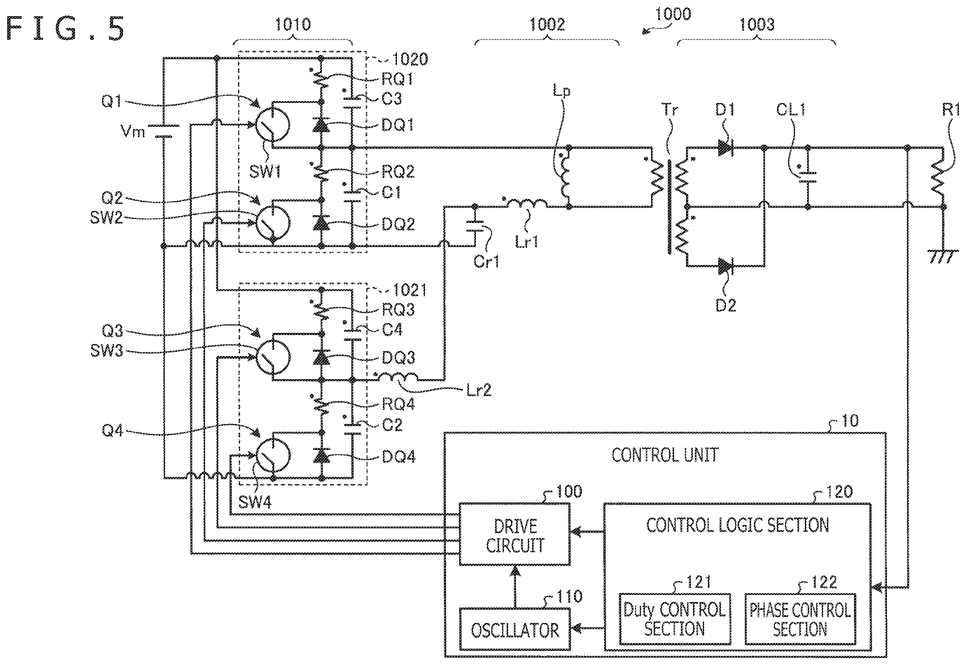

FIG. 5 is a circuit diagram of an example that takes into consideration the parasitic elements of the power supply apparatus 1 described above as the first embodiment and corresponding to the above-described FIG. 4. In FIG. 5, the configuration taking into consideration the parasitic elements of the switching elements Q3 and Q4 is similar to the configuration of the switching elements Q1 and Q2 explained above with reference to FIG. 2.

That is, the switching element Q3 includes a switch SW3, a diode DQ3, a resistor RQ3, and a capacitor C4 corresponding, respectively, to the switch SW1, the diode DQ1, the resistor RQ1, and the capacitor C3 of the switching element Q1. Further, the switching element Q4 includes a switch SW4, a diode DQ4, a resistor RQ4, and a capacitor C2 corresponding, respectively, to the switch SW1, the diode DQ1, the resistor RQ1, and the capacitor C3 in the switching element Q1.

The connection relation between the switch SW3, the diode DQ3, the resistor RQ3, and the capacitor C4 included in the switching element Q3 is similar to the connection relation between the switch SW1, the diode DQ1, the resistor RQ1, and the capacitor C3 in the above-described switching element Q1 and thus will not be discussed further in detail. Also, the connection relation between the switch SW4, the diode DQ4, the resistor RQ4, and the capacitor C2 included in the switching element Q4 is similar to the connection relation between the switch SW2, the diode DQ2, the resistor RQ2, and the capacitor C1 in the above-described switching element Q2 and thus will not be discussed further in detail. A connection point connecting the capacitor C2 with the capacitor C4 is connected with one end of the inductor Lr2.

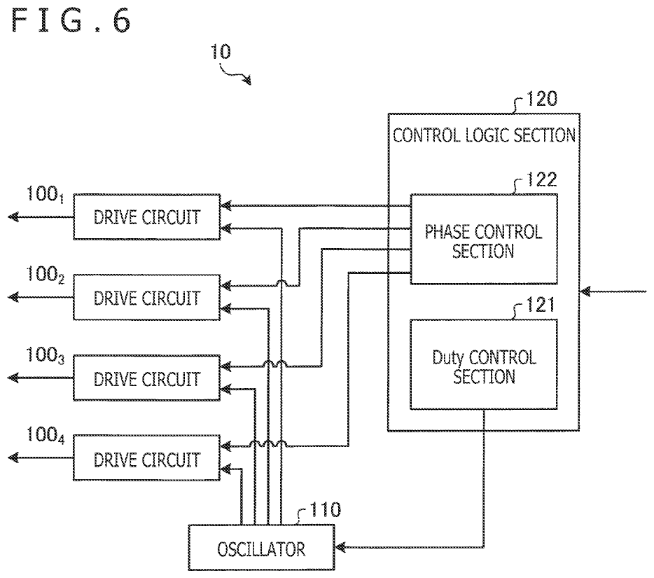

FIG. 6 is a block diagram depicting an example of a more detailed configuration of the control unit 10 usable with the first embodiment. In FIG. 6, the control unit 10 includes drive circuits 100₁, 100₂, 100₃, and 100₄, an oscillator 110, and a control logic section 120 including a duty control section 121 and a phase control section 122. On the basis of signals supplied from the oscillator 110 and from the phase control section 122, the drive circuits 100₁, 100₂, 100₃, and 100₄ output drive signals for driving, respectively, the switching elements Q1, Q2, Q3, and Q4.

In the control unit 10, the oscillator 110 generates a PWM-based signal for each of the switching elements Q1, Q2, Q3, and Q4. The duty control section 121 controls the frequency and duty of each PWM-based signal generated by the oscillator 110. The oscillator 110 supplies the generated signals to the drive circuits 100₁, 100₂, 100₃, and 100₄.

The phase control section 122 controls the phase of the PWM-based signal supplied to each of the drive circuits 100₁, 100₂, 100₃, and 100₄. For example, the phase control section 122 may independently invert the PWM-based signal supplied to each of the drive circuits 100₁, 100₂, 100₃, and 100₄. Further, the phase control section 122 allows a predetermined margin to be included in the low state of each PWM-based signal supplied to each of the drive circuits 100₁, 100₂, 100₃, and 100₄. This enables each of the switching elements Q1, Q2, Q3, and Q4 to go on and off alternately with the predetermined margin included in the off-state, which enables ZVS to be implemented.

### Operations of the First Embodiment

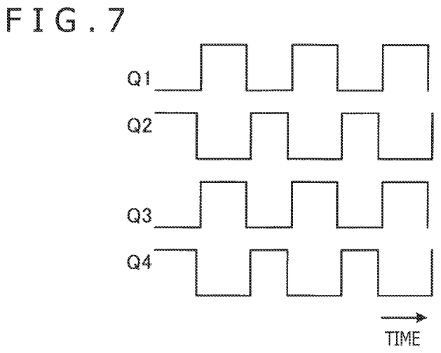

Explained next are the operations of the power supply apparatus 1 practiced as the first embodiment. As the first embodiment, the power supply apparatus 1 controls the first arm circuit section 1020 and the second arm circuit section 1021 in phase with each other. FIG. 7 is a diagram depicting typical drive signals used by the control unit 10 of the first embodiment to drive the switching elements Q1, Q2, Q3, and Q4. The signals depicted from the top down in FIG. 7 are the PWM-based drive signals for driving the switching elements Q1, Q2, Q3, and Q4, respectively. In the example of FIG. 7, the duty is 50% for each of the drive signals for driving the switching elements Q1 and Q3.

As depicted in FIG. 7, a signal obtained by inverting the drive signal for driving the switching element Q1 in the first arm circuit section 1020 is used as the drive signal for driving the switching element Q2. Likewise, a signal acquired by inverting the drive signal for driving the switching element Q3 in the second arm circuit section 1021 is used as the drive signal for driving the switching element Q4.

Also, in the example of FIG. 7, the drive signals for driving the switching elements Q1 and Q2 in the first arm circuit section 1020 are in phase with the drive signals for driving the switching elements Q3 and Q4 in the second arm circuit section 1021. That is, the switching elements Q1 and Q3 are controlled to be on and off at the same timing. Further, the switching elements Q2 and Q4 are controlled to be on and off at the same timing and in inverted relation to the switching elements Q1 and Q3.

Incidentally, in the example of FIG. 7, the low period of the drive signal for driving the switching element Q2 is controlled to be more extensive than the high period that applies to the drive signal for driving the switching element Q1 and that corresponds to the low period of the drive signal for the switching element Q2. Likewise, the low period of the drive signal for driving the switching element Q4 is controlled to be more extensive than the high period that applies to the drive signal for driving the switching element Q2 and that corresponds to the low period of the drive signal for the switching element Q4. This allows the above-described ZVS to be carried out.

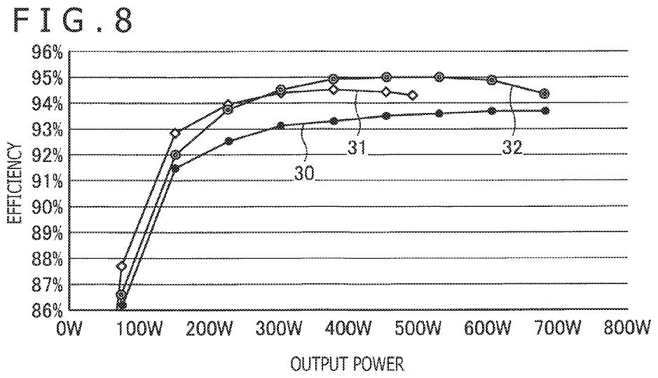

FIG. 8 is a diagram depicting an example of comparing the output of the power supply apparatus 1 as the first embodiment with the output of the power supply apparatus 1000 of the existing technology explained above with reference to FIGS. 1 and 2. In FIG. 8, the vertical axis stands for efficiency and the horizontal axis for output power. In FIG. 8, characteristic lines 30 and 31 represent examples of output of the power supply apparatus 1000 of the existing technology.

Of these characteristic lines, the characteristic line 30 denotes an output example in the case where the inductance of the inductor Lp (see FIGS. 1 and 2) is a first value (e.g., 235 [μH]); the characteristic line 31 stands for an output example in the case where the inductance of the inductor Lp is approximately twice the first value (e.g., 484 [μH]). A characteristic line 32 represents an output example of the power supply apparatus 1 as the first embodiment. In this case, the inductance of the inductor Lp is the above-mentioned second value (e.g., 484 [μH]), and the inductance of the inductor Lr2 is a value close to the second value (e.g., 520 [μH]).

Further, for switching power supply apparatuses, there exists a lower-limit input voltage down to which the output voltage can be maintained. In the description that follows, the lower-limit input voltage will be referred to as the regulated lower voltage. It is assumed that the regulated lower voltages for the configurations corresponding to the above-mentioned characteristic lines 30, 31, and 32 are 223 [V], 274 [V], and 223 [V], respectively. Generally, for LLC switching power supply apparatuses, regulated lower voltage and efficiency are in a trade-off relation with each other. That is, the higher the regulated lower voltage, the high the efficiency. On the other hand, a lowered regulated lower voltage indicates that a more extensive range of input voltages can be dealt with.

As can be understood from FIG. 8, in the case where a comparison is made between the characteristic lines 32 and 30 based on the configurations for which the regulated lower voltage is the same, the efficiency indicated by the characteristic line 32 is higher than the efficiency represented by the characteristic line 30 by approximately 0.5% to 1.5% over a range of output power ranging approximately from 70 to 700 [W]. Further, in the case of the characteristic line 31 regarding the configuration with the regulated lower voltage higher than that of the characteristic line 32, and given a predetermined output power level as a boundary (approximately 260 [W] in the example of FIG. 8), the efficiency indicated by the characteristic line 32 is higher than the efficiency represented by the characteristic line 31 by approximately 0.5% in a region where the output voltage is higher than the boundary.

Incidentally, the efficiency in this context refers to the efficiency of output power with respect to the power provided by an input direct-current power supply. In the case where the power provided by the input direct-current power supply is equal to the output power, the efficiency is 100%. Further, in the case where the output power is half the power provided by the input direct-current power supply, the efficiency is 50%.

Comparing the characteristic line 32 with the characteristic line 30 in FIG. 8 reveals that on the condition that the regulated lower voltage is the same, the power supply apparatus 1 as the first embodiment is more efficient than the power supply apparatus 1000 of the existing technology.

One reason for the above is related presumably to the conduction losses of the switching elements Q1, Q2, Q3, and Q4. It is assumed here that the switching elements Q1, Q2, Q3, and Q4 included in the power supply apparatus 1 and the switching elements Q1 and Q2 included in the power supply apparatus 1000 have a resistance of 1 [Ω] each and that the direct-current power supply Vm provides a current of 4 [A]. Further, in the case where a current I flows through an element having a resistance R, the conduction loss Los [W] of that element is calculated as Los=I×I×R.

In the power supply apparatus 1000, the direct-current power supply Vm providing the current I=4 [A] flows into the switching element Q1. In this case, the conduction loss of the switching element Q1 is given as Los=4×4×1=16 [W].

On the other hand, in the power supply apparatus 1, the direct-current power supply Vm flows into the switching elements Q1 and Q3 connected in common with the direct-current power supply Vm. Thus, the current flowing into each of the switching elements Q1 and Q3 is given as: current I×(½)=2 [A]. In this case, the conduction loss Los for the switching elements Q1 and Q3 is given as: Los=(2×2×1)×2=8 [W]. This conduction loss is half that of the above-described power supply apparatus 1000.

Further, another reason why the power supply apparatus 1 as the first embodiment is more efficient than the power supply apparatus 1000 of the existing technology is that in the power supply apparatus 1, excitation current is presumably dispersed by the first arm circuit section 1020 and by the second arm circuit section 1021. That is, with the excitation current dispersed, conduction losses are presumably reduced as in the case of the above-described conduction losses Los for the switching elements Q1, Q2, Q3, and Q4.

Here, the regulated lower voltage is affected generally by the value of the inductor Lp. In the power supply apparatus 1 as the first embodiment, the inductor Lr2 added to the power supply apparatus 1000 of the existing technology may be considered to be connected in parallel with the inductor Lp as a whole circuit. The capacitance of each of the inductors Lr2 and Lp connected in parallel is selected in such a manner that the combined capacitance of these inductors becomes equal to the capacitance of the inductor Lp in the power supply apparatus 1000. This makes the regulated lower voltage approximately the same for both the configuration of the power supply apparatus of the existing technology corresponding to the characteristic line 30 and the configuration of the power supply apparatus 1 as the first embodiment corresponding to the characteristic line 32.

As described above, the power supply apparatus 1 as the first embodiment is made more efficient than the power supply apparatus 1000 of the existing technology by simply adding two switching elements Q3 and Q4 and one inductor Lr2 to the configuration of the power supply apparatus 1000. This makes the power supply apparatus 1 as the first embodiment more useful than the power supply apparatus 1000 of the existing technology.

### First Alternative Example of the First Embodiment

A first alternative example of the first embodiment is explained next. As discussed above, in FIG. 8, the characteristic line 32 representing the power supply apparatus 1 as the first embodiment is intersected by the characteristic line 31 at a given point (e.g., where output power=260 [W]). At output voltage levels below that point, the efficiency of the power supply apparatus 1 is lower than that of the power supply apparatus 1000 of the existing technology. Thus, in the case where the regulated lower voltage is high, the first alternative example of the first embodiment switches the operation of the second arm circuit section 1021 at a switching point represented by the intersection point between the characteristic lines 31 and 32.

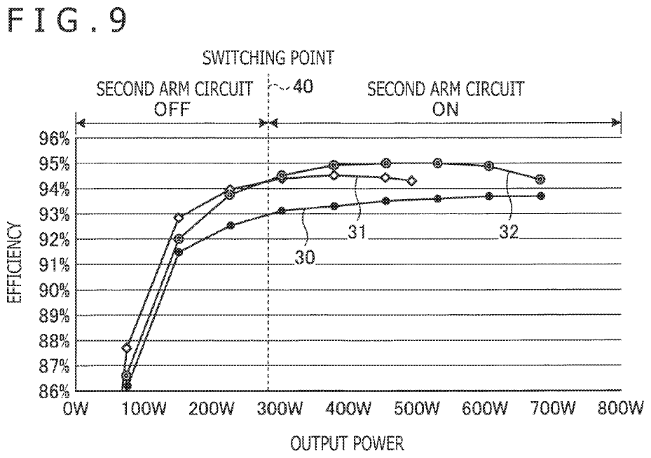

FIG. 9 is a diagram explaining more specifically the control performed by the first alternative example of the first embodiment. In FIG. 9, characteristic lines 30, 31, and 32 are the same as the characteristic lines 30, 31, and 32 discussed above with reference to FIG. 8. As depicted in FIG. 9, in the case where the output power is lower than the power level at a switching point 40, the power supply apparatus 1 stops the operation of the second arm circuit section 1021; in the case where the output power is equal to or higher than the power level at the switching point 40, the power supply apparatus 1 causes the second arm circuit section 1021 to operate.

That is, as depicted in FIG. 9, the characteristic line 31 corresponding to the configuration with the high regulated lower voltage indicates an overall efficiency level higher than the efficiency levels represented by the characteristic line 31 corresponding to the configuration with the regulated lower voltage lower than that of the configuration corresponding to the characteristic line 30. Meanwhile, at low load, i.e., at output power levels lower than the power level at the switching point 40, the characteristic line 31 indicates higher efficiency levels than the characteristic line 32 for the configuration of the power supply apparatus 1 as the first embodiment and corresponding to the regulated lower voltage equivalent to that of the characteristic line 30. At high load, i.e., at output power levels equal to or higher than the power level at the switching point 40, the characteristic line 31 indicates lower efficiency levels than the characteristic line 32. Also, as discussed above, in the configuration of the power supply apparatus 1000 corresponding to the characteristic line 31, the inductance of the inductor Lp is 484 [μH]. In the configuration of the power supply apparatus 1 corresponding to the characteristic line 32, the inductance of the inductor Lp is also 484 [μH].

In the first alternative example of the first embodiment, the inductance of the inductor Lp in the power supply apparatus 1 is selected as descried above. More specifically, the inductance of the inductor Lp in the power supply apparatus 1 is selected to be equal to the inductance of the inductor Lp in the high-efficiency configuration represented by the characteristic line 31. Further, the inductance of the inductor Lp in the power supply apparatus 1 is selected in such a manner that the combined inductance of the inductors Lp and Lr2 connected in parallel becomes approximately equal to the inductance of the inductor Lp in the configuration corresponding to the low regulated lower voltage denoted by the characteristic line 30.

When the power supply apparatus 1 practiced as the first alternative example of the first embodiment is configured as described above, the operation of the second arm circuit section 1021 is stopped (off) in the case where the output power is lower than the power level at the switching point 40 and is activated (on) where the output power is equal to or higher than the power level at the switching point 40. This provides high efficiency over a wide range of output power levels. This also makes the power supply apparatus 1 as the first alternative example of the first embodiment more useful than the existing power supply apparatus 1000.

Incidentally, the operation of the second arm circuit section 1021 may be stopped by setting to 0% the duty of the drive signals supplied to the switching elements Q3 and Q4, for example. The control unit 10 obtains the output power level from the power supplied from the output circuit section 1003, for example, and determines whether or not the obtained output power is lower than the power level at the switching point 40.

In the case of determining that the output power is lower than the power level at the switching point 40, the control unit 10 controls the oscillator 110 in a manner causing the duty control section 121 to generate signals with a duty of 0% for the switching elements Q3 and Q4. The oscillator 110 supplies the signals with the 0% duty to the drive circuits 100₃ and 100₄ for driving the switching elements Q3 and Q4.

Incidentally, for the switching elements Q1 and Q2 in the first arm circuit section 1020, the duty control section 121 controls the oscillator 110 to generate signals similar to the signals before the switching.

### Second Alternative Example of the First Embodiment

A second alternative example of the first embodiment is explained next. The second alternative example deals with the case where the output power transitions from below the power level at the switching point 40 to a level equal to or higher than the level at the switching point 40 in the above-described first alternative example of the first embodiment, for example.

In the case where the output power transitions from below the power level at the switching point 40 to a level equal to or higher than the level at the switching point 40, the power supply apparatus 1 operates, for example, as follows: In a state where the output power is lower than the power level at the switching point 40, the first arm circuit section 1020 operates and the second arm circuit section 1021 stops. Upon transition from this state to a state where the output voltage is equal to or higher than the level at the switching point 40, the second arm circuit section 1021 is switched from the stopped state to the operating state while the first arm circuit section 1020 is continuously operating in the power supply apparatus 1.

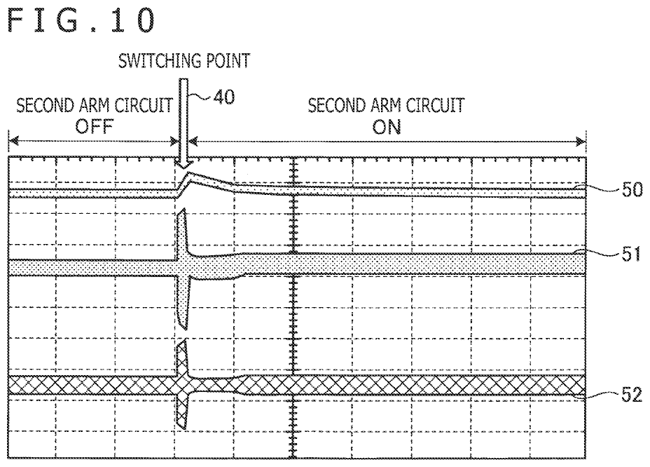

In this case, the moment the second arm circuit section 1021 is switched from the stopped state to the operating state, some components of the power supply apparatus 1 incur significant increases in voltage and current. FIG. 10 is a diagram depicting an example of how components incur variations when the operation of the second arm circuit section 1021 is switched from the stopped state to the operating state. FIG. 10 illustrates measurements taken by use of the circuits discussed above with reference to FIGS. 4 and 5.

In FIG. 10, the vertical axis stands for voltage or current, and the horizontal axis represents time. The period chronologically preceding the switching point 40 is a period in which the second arm circuit section 1021 is in the stopped state (duty=0%). At the switching point 40, the second arm circuit section 1021 is caused to transition from the stopped state to the operating state (duty=50%). A characteristic 50 denotes the output voltage from the output circuit section 1003 in the power supply apparatus 1. Characteristics 51 and 52 represent, respectively, the current and voltage of the capacitor Cr1 in the resonant circuit section 1002.

Before and after the switching point 40, the frequency of the drive signals output from the drive circuits 100₁ to 100₄ varies. In the example of FIG. 10, before the switching point 40 where the switching elements Q1 and Q2 are driven with the duty=50% and where the switching elements Q3 and Q4 are driven with the duty=0%, the frequency of the drive signals is approximately 80 kHz. On the other hand, after the switching point 40 where the switching elements Q1 to Q4 are driven with the duty=50%, the frequency of the drive signals is approximately 122 kHz.

Also, as indicated by the characteristics 51 and 52 in FIG. 10, the capacitor Cr1 temporarily incurs sudden increases in voltage and current at the switching point 40. At this time, it is necessary to change the drive signal frequency from 80 to 122 kHz. However, due to a control delay, the drive signal frequency does not change instantaneously. An excess supply of power thus causes the capacitor Cr1 to incur sudden increases in voltage and current. At the same timing corresponding to the variations in voltage and current in the capacitor Cr1, there is a significant increase in output voltage as indicated by the characteristic 50. Such variations in output voltage are not desirable for the power supply apparatus 1.

In the second alternative example of the first embodiment, the control for switching the second arm circuit section 1021 from the stopped state to the operating state at the switching point 40 is carried out by gradually varying the duty of the drive signals supplied to the second arm circuit section 1021.

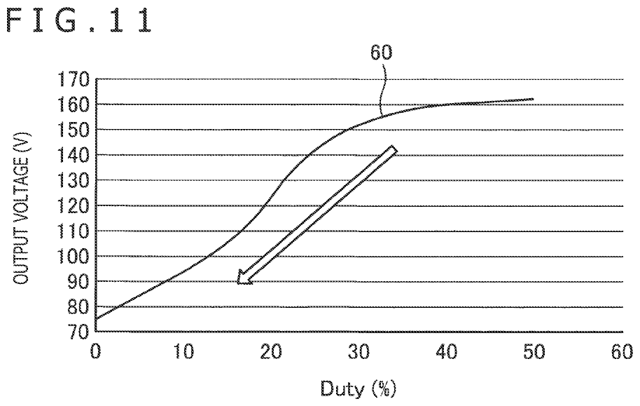

FIG. 11 is a diagram depicting an example of how output voltage measurements vary when the duty of the drive signals supplied to the second arm circuit section 1021 is gradually varied by the second alternative example of the first embodiment. In the example of FIG. 11, the duty of the drive signals supplied to the switching elements Q3 and Q4 in the second arm circuit section 1021 is reduced gradually from 50% to 0%, as indicated by an arrow in FIG. 11. FIG. 11 reveals that the output voltage of the power supply apparatus 1 gradually drops in keeping with this change in the duty of the drive signals, as indicated by a characteristic line 60.

On the basis of the result indicated in FIG. 11, the second alternative example of the first embodiment performs control such that when the second arm circuit section 1021 is switched from the stopped state to the operating state while the first arm circuit section 1020 is operating, the duty of the drive signal supplied to each of the switching elements Q3 and Q4 in the second arm circuit section 1021 is gradually increased. As explained above with reference to FIG. 10, this control is expected to suppress sudden variations in voltage and current in the capacitor Cr1 as well as the variations in output voltage at the switching point 40. This also makes the power supply apparatus 1 as the second alternative example of the first embodiment more useful than the power supply apparatus 1000 of the existing technology.

### Operations in the Case where the Second Arm Circuit is Brought into the Stopped State

Incidentally, in the case where the second arm circuit section 1021 is switched from the operating state to the stopped state while the first arm circuit section 1020 is operating, the above-described significant increase in output voltage or sudden rises in voltage and current in the capacitor Cr1 do not occur.

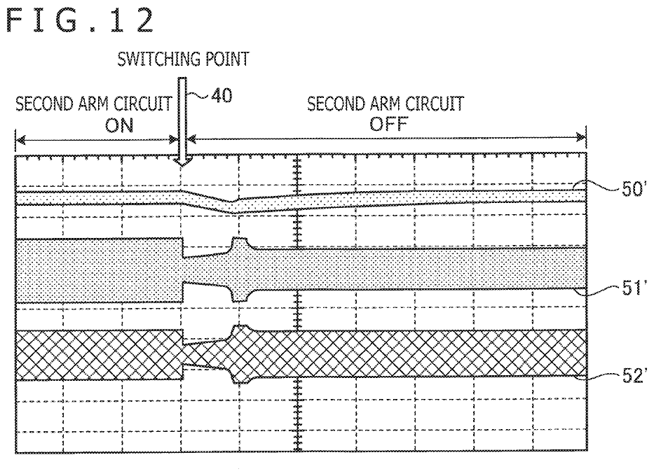

FIG. 12 is a diagram depicting how components incur variations when the operation of the second arm circuit section 1021 is switched from the operating state to the stopped state in the second alternative example of the first embodiment. As with FIG. 10, FIG. 12 illustrates measurements taken by use of the circuits discussed above with reference to FIGS. 4 and 5.

In FIG. 12, the period chronologically preceding the switching point 40 is a period in which the second arm circuit section 1021 is in the operating state (duty=50%). At the switching point 40, the second arm circuit section 1021 is caused to transition to the stopped state (duty=0%). The capacitor Cr1 temporarily incurs sudden drops in voltage and current at the switching point 40, as indicated by characteristics 51′ and 52′ in FIG. 12. On the other hand, there occur smaller variations in output voltage at the switching point 40 indicated by a characteristic 50′ than the variations depicted by the above-described characteristic 50 in FIG. 10.

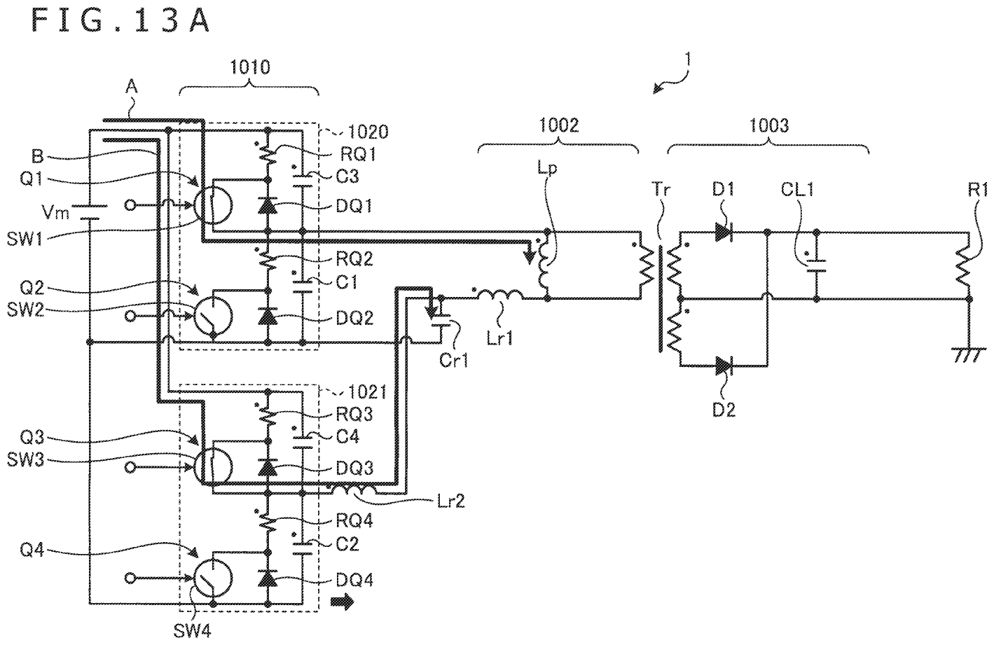

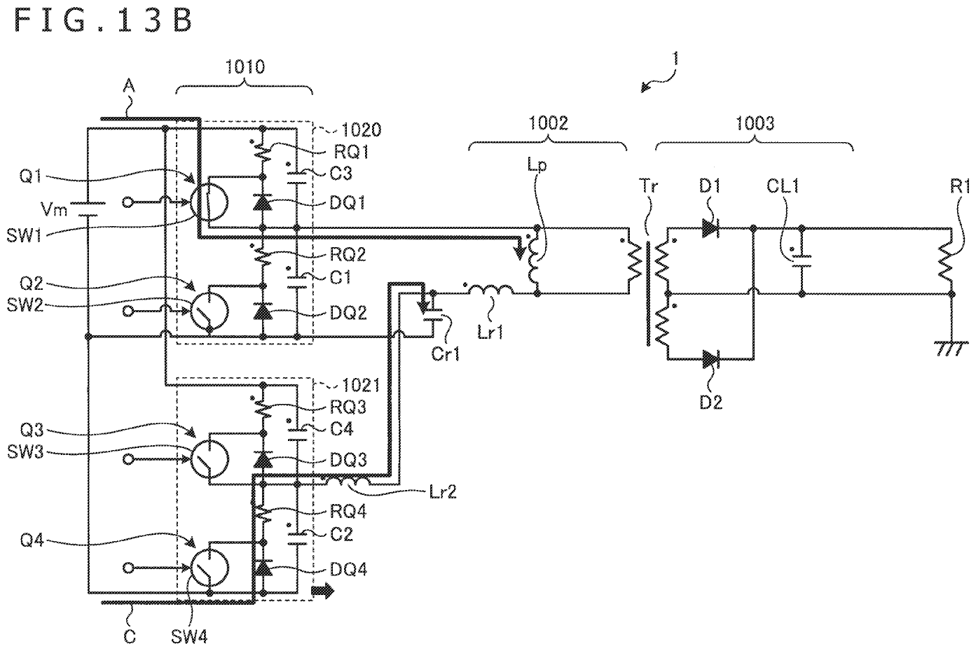

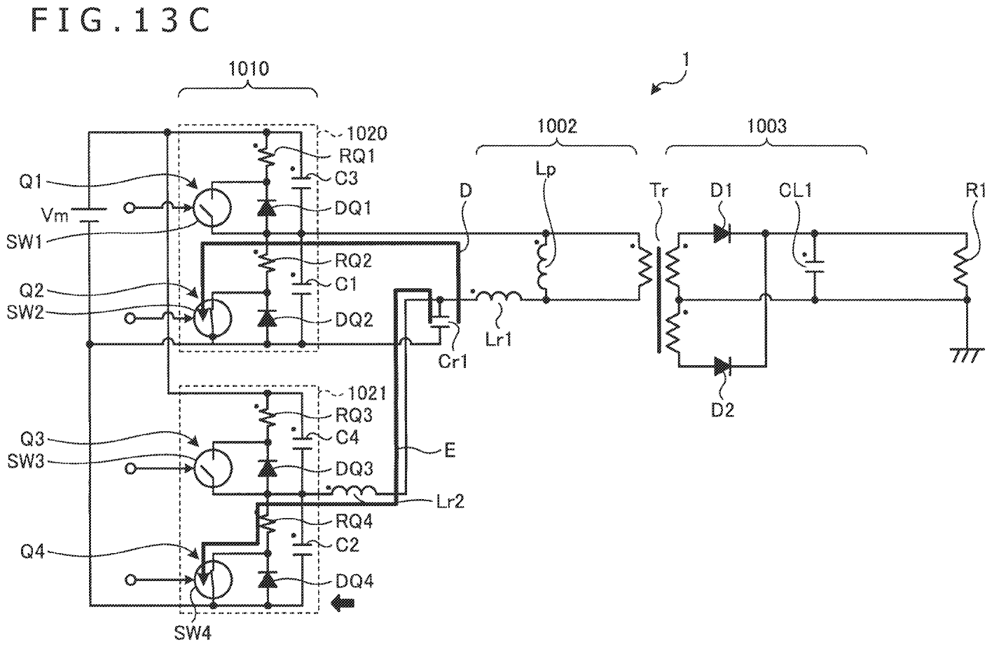

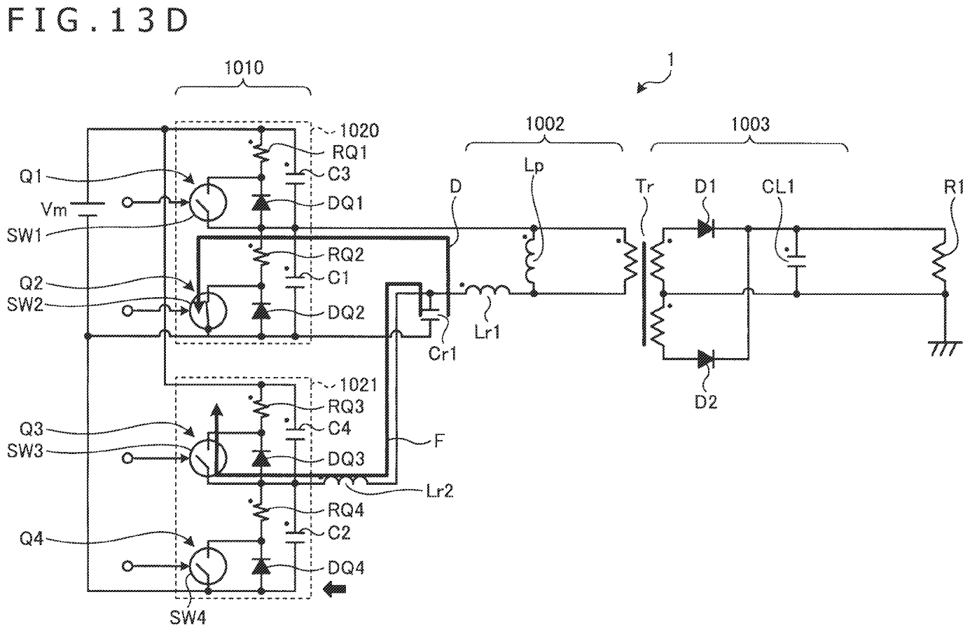

FIGS. 13A to 13D are diagrams for examining how variations in output voltage at the switching point 40 are reduced by the second alternative example of the first embodiment. FIGS. 13A and 13B depict the operation of the first arm circuit section 1020 corresponding to the operation discussed above with reference to FIG. 3A. In the first arm circuit section 1020, the switching element Q1 (switch SW1) is in the on-state and the switching element Q2 (switch SW2) is in the off-state.

In FIG. 13A, the current from the direct-current power supply Vm flows through the switch SW1 in the first arm circuit section 1020 past the inductor Lp along a path A corresponding to a solid-line arrow in FIG. 3A, the current being supplied to the series resonant circuit constituted by the inductor Lr1 and capacitor Cr1.

In the case where the first arm circuit section 1020 and the second arm circuit section 1021 are driven in phase with each other, the current from the direct-current power supply Vm is also supplied through the switch SW3 (switching element Q3) in the second arm circuit section 1021 past the inductor Lr2 along a path B to a connection point connecting the inductor r1 with the capacitor Cr1 constituting the series resonant circuit.

FIG. 13B is a diagram depicting the stopped state of the second arm circuit section 1021 following transition from the state in FIG. 13A. In this case, the flow of the current in the first arm circuit section 1020 is the same as that depicted in FIG. 13A (path A).

When the switch SW3 (witching element Q3) in the second arm circuit section 1021 is switched from the on-state to the off-state, an inductor current induced by the inductor Lr2 flows continuously through the diode DQ4 in the switching element Q4 as indicated by the path B in FIG. 13B. Here, if it is assumed that V_{GND} stands for grounding potential and Di for the potential across the diode DQ4, a voltage Vs induced by the inductor Lr2 (referred to as the inductive voltage Vs hereunder) is given as Vs=V_{GND}−Di.

The inductive voltage Vs of the inductor Lr2 is clamped to a predetermined voltage by the diode DQ4. Thus, the effect on the series resonant circuit constituted by the inductor Lr1 and capacitor Cr1 is assumed to be negligible. Hence, the presumably reduced effect on the secondary winding side of the transformer Tr.

FIGS. 13C and 13D depict the operation of the first arm circuit section 1020 corresponding to the operation discussed above with reference to FIG. 3C. In the first arm circuit section 1020, the switch SW1 is in the off-state and the switch SW2 is in the on-state.

In FIG. 13C, the current from the direct-current power supply Vm flows as a positive-direction current to the switch SW2 in the first arm circuit section 1020 along a path D corresponding to a solid-line arrow in FIG. 3C. Further, in the case where the first arm circuit section 1020 and the second arm circuit section 1021 are driven in phase with each other, the switch SW3 is in the off-state and the switch SW4 is in the on-state in the second arm circuit section 1021. The current from the direct-current power supply Vm is supplied to the switch SW3 in the second arm circuit section 1021 via the inductor Lr2 along a path E.

FIG. 13D is a diagram depicting the stopped state of the second arm circuit section 1021 following transition from the state in FIG. 13C. In this case, the flow of the current in the first arm circuit section 1020 is the same as that depicted in FIG. 13C (path D).

When the switch SW4 in the second arm circuit section 1021 is switched from the on-state to the off-state, an inductor current induced by the inductor Lr2 flows continuously through the diode DQ3 in the switching element Q3, as indicated by a path F in FIG. 13D. Here, if it is assumed that Vi stands for the voltage of the direct-current power supply Vm and Di for the potential across the diode DQ3, the inductive voltage Vs′ of the inductor Lr2 is given as Vs′=Vi+Di.

The inductive voltage Vs′ of the inductor Lr2 is clamped to a predetermined voltage by the diode DQ3₂. Thus, the effect on the series resonant circuit constituted by the inductor Lr1 and capacitor Cr1 is assumed to be negligible. Hence, the presumably reduced effect on the secondary winding side of the transformer Tr.

### Third Alternative Example of the First Embodiment

A third alternative example of the first embodiment is explained next. In the power supply apparatus 1 described above with reference to FIGS. 4 and 5, the inductor Lr1 constituting part of the series resonant circuit is connected directly with the capacitor Cr1. In the third alternative example of the first embodiment, by contrast, the position of the inductor Lr1 is changed from the above-described position in FIGS. 4 and 5.

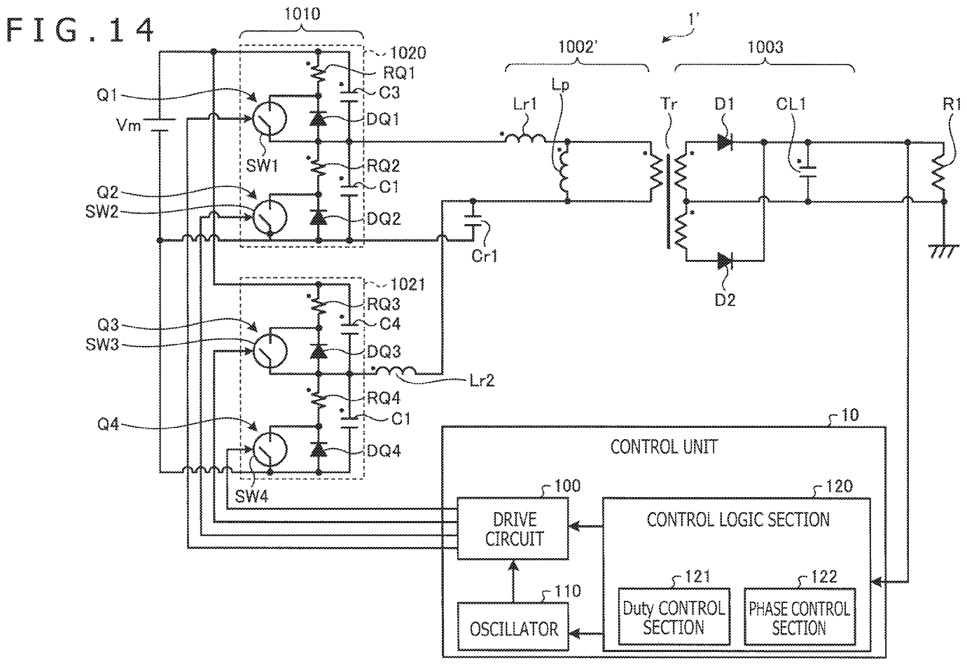

FIG. 14 is a circuit diagram depicting an example of a configuration of a power supply apparatus as a fourth alternative example of the first embodiment. In a power supply apparatus 1′ in FIG. 14, a resonant circuit section 1002′ has the inductor Lr1 in the power supply apparatus 1 in FIGS. 4 and 5 positioned between a connection point connecting the capacitor C1 with the capacitor C3 on one hand, and the second end of the primary winding of the transformer Tr on the other hand. In the example of FIG. 4, this setup corresponds to positioning the inductor Lr1 between the connection point connecting the switching element Q1 with the switching element Q2 in series with each other in the first arm circuit section 1020 on one hand, and the second end of the primary winding of the transformer Tr on the other hand.

A connection point connecting the switching element Q3 with the switching element and Q4 in series with each other in the second arm circuit section 1021 is connected via the inductor Lr2 with a connection point connecting the capacitor Cr1 with the first end of the primary winding of the transformer Tr.

As descried above, the inductor Lr1 constituting the series resonant circuit in conjunction with the capacitor Cr1 may be arranged relative to the capacitor Cr1 by way of the primary winding of the transformer Tr. This arrangement still constitutes the series resonant circuit configured with the capacitor Cr1 and the inductor Lr1.

Incidentally, the manner of controlling the power supply apparatus 1 practiced as the first embodiment as well as the manner of controlling the power supply apparatuses practiced as the first and the second alternative examples of the first embodiment may be applied unmodified to the power supply apparatus 1′ practiced as the third alternative example of the first embodiment. That is, the on/off control of the second arm circuit section 1021 in the first alternative example of the first embodiment relative to a given output power level at the switching point 40 may be applied unchanged to the power supply apparatus 1′ practiced as the third alternative example of the first embodiment. Also, the manner of performing control such as to gradually vary the duty of the drive signals for the second arm circuit section 1021 upon switchover of the second arm circuit section 1021 from the off-state to the on-state at the switching point 40 may be applied unchanged to the power supply apparatus 1′ as the third alternative example of the first embodiment.

In this manner, the power supply apparatus 1′ as the third alternative example of the first embodiment can be made more useful than the power supply apparatus 1000 of the existing technology.

### Second Embodiment

A second embodiment is explained next. In the above-described first embodiment or in the alternative examples thereof, the first arm circuit section 1020 and the second arm circuit section 1021 are driven in phase with each other. In the second embodiment, by contrast, the first arm circuit section 1020 and the second arm circuit section 1021 are driven in opposite phase to each other. Incidentally, the configuration of the power supply apparatus 1 as the first embodiment discussed above with reference to FIGS. 4 and 5 is also used unchanged for the second embodiment, so that the configuration will not be explained further in detail.

### Operations of the Second Embodiment

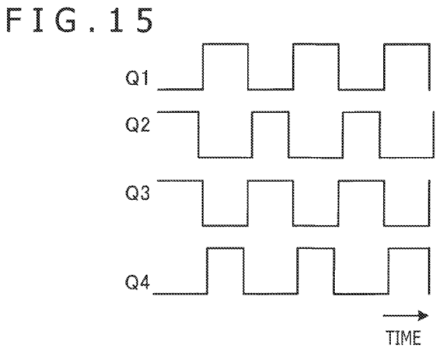

The operations of the power supply apparatus 1 practiced as the second embodiment are explained. FIG. 15 is a diagram depicting typical drive signals used by the control unit 10 of the second embodiment to drive the switching elements Q1, Q2, Q3, and Q4. FIG. 15, which corresponds to the above-described FIG. 7, depicts from the top down typical PWM-based drive signals for driving the switching elements Q1, Q2, Q3, and Q4 respectively. In the example of FIG. 7, the duty is set to 50% for the drive signals for driving the switching elements Q1 and Q3.

As depicted in FIG. 15, the drive signal for driving the switching element Q2 is a signal obtained by inverting the drive signal for driving the switching element Q1 in the first arm circuit section 1020. Likewise, the drive signal for driving the switching element Q4 is a signal obtained by inverting the drive signal for the switching element Q3 in the second arm circuit section 1021.

Here, in the second embodiment, the drive signals for driving the switching elements Q1 and Q2 in the first arm circuit section 1020 are in opposite phase to the drive signals for driving the switching elements Q3 and Q4 in the second arm circuit section 1021. That is, in the second embodiment, the switching elements Q1 and Q4 are controlled to be on and off at the same timing. Further, the switching elements Q2 and Q3 are controlled to be on and off at the same timing and in opposite phase to the switching elements Q1 and Q4.

Also, in the second embodiment, as depicted in FIG. 15 and similar to the example of FIG. 7, the low period of the drive signal for driving the switching element Q2 is controlled to be more extensive than the high period that applies to the drive signal for driving the switching element Q1 and that corresponds to the low period of the drive signal for the switching element Q2. Likewise, the low period of the drive signal for driving the switching element Q4 is controlled to be more extensive than the high period that applies to the drive signal for driving the switching element Q2 and that corresponds to the low period of the drive signal for the switching element Q4. This enables the above-described ZVS to be carried out.

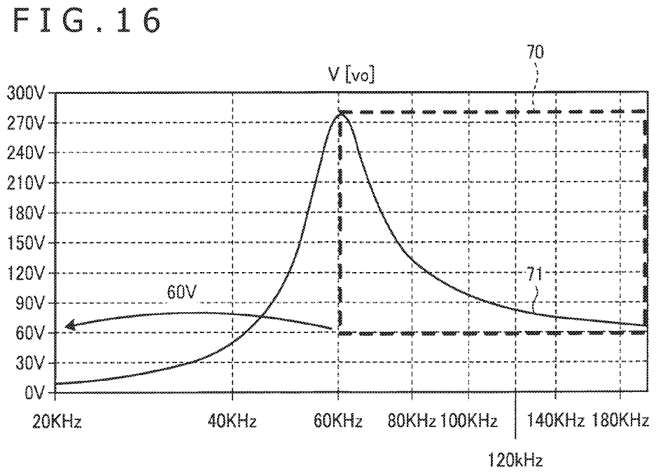

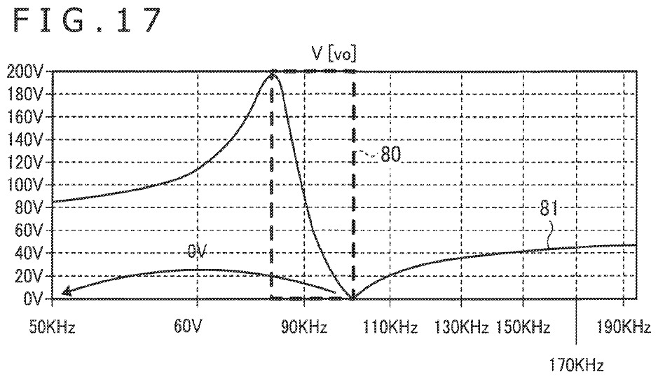

Explained below with reference to FIGS. 16 and 17 is the effect of the opposite-phase control provided by the second embodiment. FIG. 16 is a diagram depicting an example of the result of simulating characteristics using an equivalent circuit of the LLC switching power supply apparatus of the existing technology. In FIG. 16, the vertical axis denotes the output voltage on the side of the secondary winding of the transformer Tr, and the horizontal axis represents the drive frequency of each switching element.

As indicated by a characteristic line 71, the output voltage peaks at a specific drive frequency. At frequencies higher than that specific drive frequency, the varying output voltage converges toward a predetermined voltage value. In the example of FIG. 16, the output voltage peaks approximately at 280 [V]. Past the peak, the higher the drive frequency, the lower the output voltage drops toward a given voltage value, which is 60 [V], before the output voltage settles thereon. A range 70 of frequencies higher than the peak drive frequency of the output voltage is the range in which this power supply apparatus is to be used.

FIG. 17 is a diagram depicting an example of the result of simulating characteristics in the case where drive signals of opposite phase are added to an equivalent circuit of the second embodiment used in the simulation indicated by FIG. 16. In the example of FIG. 17, as indicated by a characteristic line 81, the output voltage peaks at a first drive frequency. At higher drive frequencies past the peak, the output voltage drops and dips at a second drive frequency. At still higher drive frequencies past the dip, the output voltage gradually increases.

In the example of FIG. 17, the output voltage peaks at approximately 200 [V], and dips at approximately 0 [V]. That is, where the principal arm circuit (called the main arm circuit) is supplemented with another arm circuit (called the sub arm circuit) driven in opposite phase to the main arm circuit in the LLC switching power supply apparatus, it is suggested that the output voltage can drop from its peak down to approximately 0 [V] (or exactly 0 [V]). In other words, it follows that when the drive frequency of the second arm circuit section 1021 in the power supply apparatus 1 is suitably controlled, the output voltage can be varied between the peak voltage and the dip voltage that is approximately 0 [V].

As explained above with reference to FIGS. 4, 5, and 6, the control unit 10 is capable of independently controlling each of the switching elements Q1 to Q4. Thus, a common configuration of the power supply apparatus 1 permits implementation of the control of driving the first arm circuit section 1020 and the second arm circuit section 1021 in opposite phase to each other in the second embodiment, as well as the control of driving the first arm circuit section 1020 and the second arm circuit section 1021 in phase with each other in the above-described first embodiment or in the alternative examples thereof. Also, in the control unit 10, the control logic section 120 may suitably instruct the duty control section 121, for example, to independently control the frequency of each of the drive signals output from the drive circuits 100₁ to 100₄.

For example, consider the case in which the output voltage is increased from a low voltage level close to 0 [V] up to a high voltage level, before being stabilized at that high level. In this case, in the control unit 10, the control logic section 120 instructs the duty control section 121 and the phase control section 122 initially to drive the first arm circuit section 1020 and the second arm circuit section 1021 in opposite phase to each other and to set the drive signal frequency to the frequency level at the rightmost position in the range 80 in FIG. 17, for example.

Controlled by such instructions, the duty control section 121 and the phase control section 122 cause the drive circuits 100₁ to 100₄ to output drive signals such as to drive the first arm circuit section 1020 and the second arm circuit section 1021 in opposite phase to each other and to initially provide a low-voltage output.

Thereafter, the control logic section 120 instructs the duty control section 121, for example, to increase the drive signal frequency. Given the instruction, the duty control section 121 raises the frequency of the drive signals output from the drive circuits 100₁ to 100₄.

In the case where the output voltage of the power supply apparatus 1 is determined to have reached a desired voltage level, for example, the control logic section 120 instructs the phase control section 122 to drive the first arm circuit section 1020 and the second arm circuit section 1021 in phase with each other. Controlled by this instruction, the phase control section 122 causes the drive circuits 100₁ to 100₄ to output drive signals such as to drive the first arm circuit section 1020 and the second arm circuit section 1021 in phase with each other. Here, as needed, the control logic section 120 may instruct the duty control section 121 to set the drive signal frequency to a predetermined frequency.

### Usage Examples of the Power Supply Apparatus as the Second Embodiment

One usage example of the power supply apparatus 1 practiced as the second embodiment may involve charging a secondary battery such as a lithium ion battery. For example, in the case where the secondary battery such as a lithium ion battery is to be charged, it is necessary to provide a power supply starting from as low a voltage level as possible in order to deal with processes including one for determining the battery status at an early stage of charging. With the configuration of the LLC switching power supply apparatus of the existing technology, as explained above with reference to FIG. 16, the lower limit of the available output voltage may be too high to provide the necessary voltage at an early stage of charging the secondary battery.

By contrast, the power supply apparatus 1 as the second embodiment allows the available output voltage to vary from approximately 0 [V] to the peak voltage. This presumably makes it easier to provide the necessary voltage at an early stage of charging the secondary battery. Further, in the case where a high voltage is required during the charging operation, the requirement is met by the control unit 10 causing the drive signal of the second arm circuit section 1021 to transition from an opposite-phase state to an in-phase state relative to the drive signal of the first arm circuit section 1020.

As described above, the manner of controlling the power supply apparatus 1 of the present disclosure practiced as the first embodiment or as the alternative examples thereof and the manner of controlling the power supply apparatus 1 practiced as the second embodiment may be used in suitable combinations to permit more flexible uses. This further makes the power supply apparatus 1 as the second embodiment more useful than the power supply apparatus 1000 of the existing technology.

Incidentally, the advantageous effects stated in this description are only examples and not limitative of the present technology that may also provide other advantages.

Incidentally, the present technology may be configured preferably as follows:

(1)

A power supply apparatus including:

a first arm circuit that includes a first switching element and a second switching element, the first and second switching elements being connected in series between positive and negative terminals of a direct-current power supply, the first switching element constituting an upper arm, the second switching element constituting a lower arm;

a second arm circuit that includes a third switching element and a fourth switching element, the third and fourth switching elements being connected in series between the positive and negative terminals of the direct-current power supply, the third switching element constituting an upper arm, the fourth switching element constituting a lower arm;

a transformer that includes primary winding, and secondary winding with which an output circuit outputting a direct current is connected;

a series resonant circuit that includes a first inductor and a capacitor, the first inductor having one end thereof connected with a first end of the primary winding, the capacitor being connected with the other end of the first inductor;

a second inductor that has one end thereof connected with a connection point connecting the third switching element with the fourth switching element in series; and

a control circuit that controls drive of the first arm circuit and the second arm circuit,

in which a connection point connecting the first switching element with the second switching element in series is connected with a second end of the primary winding of the transformer, and

a connection point connecting the first inductor with the capacitor is connected with the other end of the second inductor.

(2)

The power supply apparatus as stated in paragraph (1) above,

in which the control circuit drives the first arm circuit and the second arm circuit in phase with each other.

(3)

The power supply apparatus as stated in paragraph (1) or (2) above,

in which the control circuit switches the second arm circuit between a stopped state and an operating state at a predetermined level of power output from the output circuit.

(4)

The power supply apparatus as stated in any one of paragraphs (1) to (3) above,

in which the control circuit switches the second arm circuit from a stopped state to an operating state by gradually varying duty of a PWM signal for driving the second arm circuit.

(5)

The power supply apparatus as stated in paragraph (1) above,

in which the control circuit drives the first arm circuit and the second arm circuit in opposite phase to each other.

(6)

A power supply apparatus including:

a first arm circuit that includes a first switching element and a second switching element, the first and second switching elements being connected in series between positive and negative terminals of a direct-current power supply, the first switching element constituting an upper arm, the second switching element constituting a lower arm;

a second arm circuit that includes a third switching element and a fourth switching element, the third and fourth switching elements being connected in series between the positive and negative terminals of the direct-current power supply, the third switching element constituting an upper arm, the fourth switching element constituting a lower arm;

a transformer that includes primary winding, and secondary winding with which an output circuit outputting a direct current is connected;

a series resonant circuit that includes a capacitor and a first inductor, the capacitor having one end thereof connected with a first end of the primary winding, the first inductor having one end thereof connected with a second end of the primary winding;

a second inductor that has one end thereof connected with a connection point connecting the third switching element with the fourth switching element in series; and

a control circuit that controls drive of the first arm circuit and the second arm circuit,

in which a connection point connecting the first switching element with the second switching element in series is connected with the other end of the first inductor, and

the other end of the second inductor is connected with a connection point connecting the capacitor with the first end of the primary winding.

(7)

The power supply apparatus as stated in paragraph (6) above,

in which the control circuit drives the first arm circuit and the second arm circuit in phase with each other.

(8)

The power supply apparatus as stated in paragraph (6) or (7) above,

in which the control circuit switches the second arm circuit between a stopped state and an operating state at a predetermined voltage of direct-current power supply output from the output circuit.

(9)

The power supply apparatus as stated in any one of paragraphs (6) to (8) above,

in which the control circuit switches the second arm circuit from a stopped state to an operating state by gradually varying duty of a PWM signal for driving the second arm circuit.

(10)

The power supply apparatus as stated in paragraph (6) above,

in which the control circuit drives the first arm circuit and the second arm circuit in opposite phase to each other.

### REFERENCE SIGNS LIST

1, 1′, 1000: Power supply apparatus

10, 20: Control unit

100, 100₁, 100₂, 100₃, 100₄, 200: Drive circuit

110, 210: Oscillator

120, 220: Control logic section

1001, 1010: Arm circuit section

1002: Resonant circuit section

1003: Output circuit section

1020: First arm circuit section

1021: Second arm circuit section

C1, C2, C3, C4, Cr1: Capacitor

LI1, Lr1, Lr2, Lp: Inductor

D1, D2, DQ1, DQ2, DQ3, DQ4: Diode

RQ1, RQ2, RQ3, RQ4: Resistor

Q1, Q2, Q3, Q4: Switching element

SW1, SW2, SW3, SW4: Switch

1. A power supply apparatus comprising:
a first arm circuit that includes a first switching element and a second switching element, the first and second switching elements being connected in series between positive and negative terminals of a direct-current power supply, the first switching element constituting an upper arm, the second switching element constituting a lower arm;
a second arm circuit that includes a third switching element and a fourth switching element, the third and fourth switching elements being connected in series between the positive and negative terminals of the direct-current power supply, the third switching element constituting an upper arm, the fourth switching element constituting a lower arm;
a transformer that includes primary winding, and secondary winding with which an output circuit outputting a direct current is connected;
a series resonant circuit that includes a first inductor and a capacitor, the first inductor having one end thereof connected with a first end of the primary winding, the capacitor being connected with the other end of the first inductor;
a second inductor that has one end thereof connected with a connection point connecting the third switching element with the fourth switching element in series; and
a control circuit that controls drive of the first arm circuit and the second arm circuit,
wherein a connection point connecting the first switching element with the second switching element in series is connected with a second end of the primary winding of the transformer, and
a connection point connecting the first inductor with the capacitor is connected with the other end of the second inductor.

2. The power supply apparatus according to claim 1,
wherein the control circuit drives the first arm circuit and the second arm circuit in phase with each other.

3. The power supply apparatus according to claim 1,
wherein the control circuit switches the second arm circuit between a stopped state and an operating state at a predetermined level of power output from the output circuit.

4. The power supply apparatus according to claim 1,
wherein the control circuit switches the second arm circuit from a stopped state to an operating state by gradually varying duty of a PWM signal for driving the second arm circuit.

5. The power supply apparatus according to claim 1,
wherein the control circuit drives the first arm circuit and the second arm circuit in opposite phase to each other.

6. A power supply apparatus comprising:
a first arm circuit that includes a first switching element and a second switching element, the first and second switching elements being connected in series between positive and negative terminals of a direct-current power supply, the first switching element constituting an upper arm, the second switching element constituting a lower arm;
a second arm circuit that includes a third switching element and a fourth switching element, the third and fourth switching elements being connected in series between the positive and negative terminals of the direct-current power supply, the third switching element constituting an upper arm, the fourth switching element constituting a lower arm;
a transformer that includes primary winding, and secondary winding with which an output circuit outputting a direct current is connected;
a series resonant circuit that includes a capacitor and a first inductor, the capacitor having one end thereof connected with a first end of the primary winding, the first inductor having one end thereof connected with a second end of the primary winding;
a second inductor that has one end thereof connected with a connection point connecting the third switching element with the fourth switching element in series; and
a control circuit that controls drive of the first arm circuit and the second arm circuit,
wherein a connection point connecting the first switching element with the second switching element in series is connected with the other end of the first inductor, and
the other end of the second inductor is connected with a connection point connecting the capacitor with the first end of the primary winding.

7. The power supply apparatus according to claim 6,
wherein the control circuit drives the first arm circuit and the second arm circuit in phase with each other.

8. The power supply apparatus according to claim 6,
wherein the control circuit switches the second arm circuit between a stopped state and an operating state at a predetermined voltage of direct-current power supply output from the output circuit.

9. The power supply apparatus according to claim 6,
wherein the control circuit switches the second arm circuit from a stopped state to an operating state by gradually varying duty of a PWM signal for driving the second arm circuit.

10. The power supply apparatus according to claim 6,
wherein the control circuit drives the first arm circuit and the second arm circuit in opposite phase to each other.
